(19) United States
(12) Patent Application Publication
(10) Pub. No.: US 2016/0167064 A1
(43) Pub. Date: Jun. 16, 2016

(54) MEANS FOR CONTROLLING A NOZZLE, RINSING HEAD, AND INSPECTION AND/OR CLEANING SYSTEM

(71) Applicant: iPEK International GmbH, Sulzberg (DE)

(72) Inventors: Fabian ZAHND, Kempten (DE); Peter HENN, Krugzell (DE)

(21) Appl. No.: 14/966,281

(22) Filed: Dec. 11, 2015

(30) Foreign Application Priority Data
Dec. 11, 2014 (DE) 20 2014 105 997.0

(51) Int. Cl. B05B 1/30

(52) U.S. Cl. CPC B05B 1/3026

(57) ABSTRACT

A controller for a nozzle, in particular, a nozzle of a rinsing head of an inspection or cleaning system is provided, wherein a setting means made from a shape memory member is assigned to the nozzle, by means of which an operational state (open/closed), a cross section of the fluid outlet opening of the nozzle, or an outlet angle of the fluid being discharged from the nozzle are adjustable.

### CROSS REFERENCE TO RELATED APPLICATIONS

This application claims priority to German Application No. 10 2014 105 997.0, filed Dec. 11, 2014, the contents of which are incorporated by reference herein.

### TECHNICAL FIELD

The invention relates to a means for controlling nozzles, in particular, a rinsing nozzle of an inspection and/or cleaning system, as well as a rinsing head having at least one nozzle and at least one means for controlling nozzles according to the invention, and an inspection and/or cleaning system with a rinsing nozzle according to the invention.

### BACKGROUND

For executing pipe inspection or restoration work it is known to use pipe inspection and/or maintenance systems or sewer cleaning systems, which may be inserted into a sewage pipe, and which may be moved, for example, moved forward or advanced, within the sewage pipe.

For the maintenance of sewage pipes it is known to equip the systems used for this with a rinsing head or several rinsing heads, wherein the rinsing heads may respectively comprise one or more nozzles (also referred to as rinsing nozzles). The nozzles have a nozzle housing, in which a water channel is formed, through which the rinsing water supplied to the rinsing head may flow and from which it may be discharged with a certain pressure from the water channel.

For controlling the nozzle, for example, an outlet angle of the rinsing water being discharged from the nozzle, or the state of operation (open/closed/partially open), for example, the entire rinsing head has to be moved in order to modify the angle of the water jet being discharged with respect to the inner wall of the pipe, or complex mechanical locking devices have to be integrated into the rinsing head in order to inhibit the water outlet from the individual nozzles as far as the rinsing head has several nozzles. Alternatively, the water outlet may be interrupted by interrupting the complete water supply to the rinsing head. However, by this action, all nozzles of the rinsing head are involved. In order to modify the outlet angle of the water being discharged from the nozzle, it is known to modify the position of the nozzle relative to the rinsing head. Also for this, complex mechanical devices, or electromechanical devices being correspondingly adapted for this have to be integrated into the rinsing head.

These solutions, however, have the disadvantage that, on the one hand, the possible applications of a rinsing head are reduced, and that, on the other hand, the rinsing head has to be sized correspondingly large in order to be able to integrate the mechanical or electromechanical setting means for the nozzles into the rinsing head. For channels or water pipes having a smaller diameter, only rinsing heads which are sized correspondingly small can be used, wherein due to the lack of flexibility of smaller rinsing heads for various application scenarios, also different rinsing heads have to be used.

### SUMMARY

Therefore, the present invention is based on the object to at least partially avoid the disadvantages mentioned above, and to provide solutions for controlling at least one nozzle, in particular, a rinsing head, enabling for a particularly compact configuration of the rinsing head, a nevertheless flexible application of the nozzles or the rinsing head.

According to the invention, this object is solved by a means for controlling at least one nozzle by means of a rinsing head, which comprises a nozzle and at least one means for controlling the nozzle according to the invention, as well as an inspection and/or cleaning system according to the independent claims. Preferred embodiments and configurations of the invention are specified in the respective dependent claims.

Accordingly, a means for controlling at least one nozzle, in particular, a rinsing head of an inspection and/or cleaning system is provided according to the invention, wherein:
a. the nozzle comprises a nozzle housing, in which a fluid channel is formed, through which a fluid, in particular, water, being supplied to the nozzle under pressure flows,
b. control means are assigned to the nozzle, by means of which a state of operation (open/closed/partially open), a cross section of the fluid outlet opening of the nozzle, and/or an outlet angle of the fluid being discharged from the nozzle is adjustable,
c. the control means is coupled to a setting means in order to move the control means relative to the nozzle housing or relative to the fluid channel,
   and wherein
d. the setting means comprises at least one shape memory member, which changes its shape depending on at least one parameter, wherein the change of shape of the shape memory member causes the movement of the control means relative to the nozzle housing.

The shape memory member may comprise an elongated shape memory member, which changes its length depending on the parameter, and which applies a setting force to the control means due to the change of length.

The setting means may additionally comprise a pulling member, which, on the one hand, is connected to the shape memory member, and, on the other hand, to the control means.

The parameter may be the temperature of the shape memory member, wherein the temperature required for a predetermined movement of the control means relative to the nozzle housing may be applied to the shape memory member directly or indirectly.

It is advantageous, if the shape memory member is coupled to a control and/or setting means, which is adapted to apply the temperature required for a predetermined movement of the control means relative to the nozzle housing to the shape memory member.

The control and/or setting means may be adapted to feed electrical current into the shape memory member, or to conduct it through the shape memory member in order to thereby heat it up.

The means may comprise at least one reset means, wherein a reset force of the reset means acts against the setting force of the setting means.

The reset means may comprise at least a spring member.

According to an embodiment of the invention, the control means may comprise a cylindrical bolt, which is arranged transversely to the fluid channel and so as to be rotational about its longitudinal axis, and which has a diameter being larger than the diameter of the fluid channel, wherein the bolt has a channel running transversely through the bolt.

The bolt may be rotatable by means of the setting means from a first position, in which the channel of the bolt at least partially clears the fluid channel of the nozzle for enabling the fluid to flow through the fluid channel, to a second position, in which the bolt blocks the fluid channel of the nozzle for fluid from flowing through the fluid channel.

The bolt may be arranged relative to the fluid channel of the nozzle such that the channel of the bolt forms a water outlet channel of the nozzle, wherein a rotation of the bolt causes a modification of the outlet angle of the fluid being discharged from the nozzle.

The channel of the bolt may have on the fluid inlet side, a larger diameter than on the fluid outlet side, preferably, a larger diameter than the end of the fluid channel of the nozzle facing the bolt.

According to an embodiment of the invention, the control means may comprise a latch being arranged transversely to the fluid channel of the nozzle, and being movable together with the setting means in radial direction relative to the fluid channel, wherein the latch is movable from a first position, in which the latch blocks the fluid channel of the nozzle for the fluid flow through the fluid channel, into a second position, in which the latch at least partially clears the fluid channel of the nozzle for a fluid flow through the fluid channel.

According to an embodiment of the invention, the control means may comprise a circular aperture with a first bolt, which is arranged at the nozzle rotatably at the fluid channel outlet side, wherein in a first rotational position of the circular aperture relative to the nozzle, the first hole corresponds to a fluid outlet opening of the fluid channel of the nozzle, and allows for fluid discharge from the fluid channel through the first hole.

The circular aperture may comprise a second hole, wherein the first hole has a diameter different from the diameter of the second hole, and wherein the circular aperture is rotatable by means of the setting means from the first rotational position into a second rotational position relative to the nozzle, according to which the second hole corresponds to the fluid outlet opening of the fluid channel of the nozzle and allows for fluid discharge from the fluid channel through the second hole.

The circular aperture may be rotational by means of the setting means from the first rotational position and/or from the second rotational position into a third rotational position relative to the nozzle, according to which the circular aperture inhibits fluid discharge from the fluid channel.

The circular aperture may comprise a number of first holes and a number of second holes.

The pulling member may be directed in radial direction at least partially around the circular aperture. The pulling member may be fixed to the circular aperture.

A section of the reset means in radial direction may be directed at least partially around the circular aperture, and may be fixed to the circular aperture. Alternatively, the pulling member directed around the circular aperture may be coupled to the reset means.

According to an embodiment of the invention, the control means may comprise a diaphragm, in particular, an iris diaphragm, with several blades movable relative to each other and transversely to the fluid channel, which are arranged at the nozzle at the fluid channel outlet side, wherein at least one of the blades is coupled to the setting means, and is movable by the setting means, wherein a movement of the blades causes an increase or a reduction of the cross section of the fluid outlet opening of the nozzle.

In the nozzle housing, several fluid channels may be formed.

According to an embodiment of the invention, the control means may comprise a slider, which is movable back and forth with the setting means in radial direction transversely to the longitudinal axis of the nozzle between a first slider position and a second slider position, wherein in the nozzle housing, at least one first fluid channel and one second fluid channel are formed, wherein in the first slider position, the slider prevents the fluid discharge from the first fluid channel, and wherein in the second slider position, the slider prevents the fluid discharge from the second fluid channel.

The slider may be movable by means of the setting means into a third slider position, which is located between the first slider position and the second slider position, and wherein in the third slider position, the slider prevents the fluid discharge from both fluid channels, or allows the fluid discharge from both fluid channels.

The first fluid channel may run in a predetermined angle being different from zero with respect to the second fluid channel such that the outlet angle of the fluid being discharged from the first fluid channel is different from the fluid being discharged from the second fluid channel.

According to an embodiment of the invention, the nozzle housing may comprise a nozzle ring, in which at least one fluid channel is formed, wherein the nozzle ring is supported rotatably in radial direction on the rinsing head, and wherein the control means comprises at least one brake shoe, which is movable together with the setting means, and which is pushable against an inner or outer wall portion of the nozzle ring, in order to inhibit rotation of the nozzle ring.

According to an embodiment of the invention, the nozzle housing may comprise a nozzle ring, in which a fluid channel is formed, wherein the nozzle ring is supported rotatably in radial direction on the rinsing head, and wherein the control means comprises a latch, which is movable together with the setting means relative to the nozzle in radial direction outwards and inwards, wherein the nozzle ring comprises a recess, with which the latch can be brought into engagement, in order to inhibit a rotation of the nozzle ring.

According to an embodiment of the invention, the control means may comprise a rinsing hose, in which a water channel is formed, and at the front end of which at least one nozzle or a rinsing head are arranged.

The rinsing hose, in particular, the wall of the rinsing hose, may comprise at least sectionally a shape memory member.

The setting means may be arranged in the rinsing hose and parallel to the longitudinal axis and outside of the longitudinal axis of the rinsing hose such that a shortening of the shape memory member of the setting means causes a bending of the rinsing hose.

At least three setting means may be arranged in the rinsing hose, which are arranged in circumferential direction evenly such that the rinsing hose may be bent in any arbitrary direction.

The control means may comprise a ring being arranged coaxially with respect to the fluid channel within the fluid channel, wherein the ring forms the shape memory member.

The ring may change its shape upon application of a parameter such that the diameter of the circular aperture is reduced.

Further, a rinsing head with at least one nozzle according to the invention and at least one means for controlling the nozzle according to the invention are provided.

Further, a rinsing head with at least one nozzle and a receiving space, in which an imaging means may be arranged, is provided, wherein the opening of the receiving space may be substantially closed by a preferably pivotable protection shutter, wherein a setting means is assigned to the protection shutter, and wherein the setting means comprises at least one shape memory member, which, depending on at least one parameter, changes its shape, wherein the change of shape of the shape memory member causes the movement of the protection shutter with respect to the rinsing head.

The imaging means may be arranged within the receiving space releasably.

Further, an inspection and/or cleaning system, in particular, a sewage pipe inspection and/or cleaning system, is provided by the invention, which comprises at least one nozzle and at least one means for controlling the nozzle and/or at least one rinsing head according to the invention are provided by the invention.

### BRIEF DESCRIPTION OF THE DRAWINGS

Further details and features of the invention as well as concrete, in particular, preferred embodiments of the invention can be derived from the following description in connection with the drawing, in which

FIG. 1 shows a first embodiment of a means for controlling a state of operation of a nozzle according to the invention;

FIG. 2 shows an embodiment of a means for controlling a state of operation and/or a water outlet angle of the nozzle according to the invention;

FIG. 3 shows an embodiment of a means for controlling a state of operation of a nozzle according to the invention;

FIGS. 4A and 4B show a further example of a means according to the invention for controlling a state of operation and/or a cross section of the outlet opening of a nozzle;

FIG. 5 shows an example of a means according to the invention for controlling a cross section of a water outlet opening of a nozzle;

FIGS. 6A-C show an example of a means according to the invention for controlling the state of operation and/or the water outlet angle of a nozzle;

FIG. 7 shows an example of a means according to the invention for controlling a rotation of a nozzle ring;

FIG. 8 shows a further example of a means according to the invention for controlling a rotation of a nozzle ring;

FIG. 9 shows an example of a rinsing head according to the invention, in which an imaging means is arranged additionally;

FIG. 10 shows an example of a means according to the invention for controlling a nozzle, wherein the rinsing head is arranged at a rinsing hose;

FIG. 11 shows a preferred embodiment of the rinsing hose shown in FIG. 10; and

FIGS. 12A-D show still further example of a means for controlling a nozzle according to the invention, with FIGS. 12A and C showing the means in a first and second condition and FIGS. 12B and D showing cross sections of the means in each respective condition.

### DETAILED DESCRIPTION

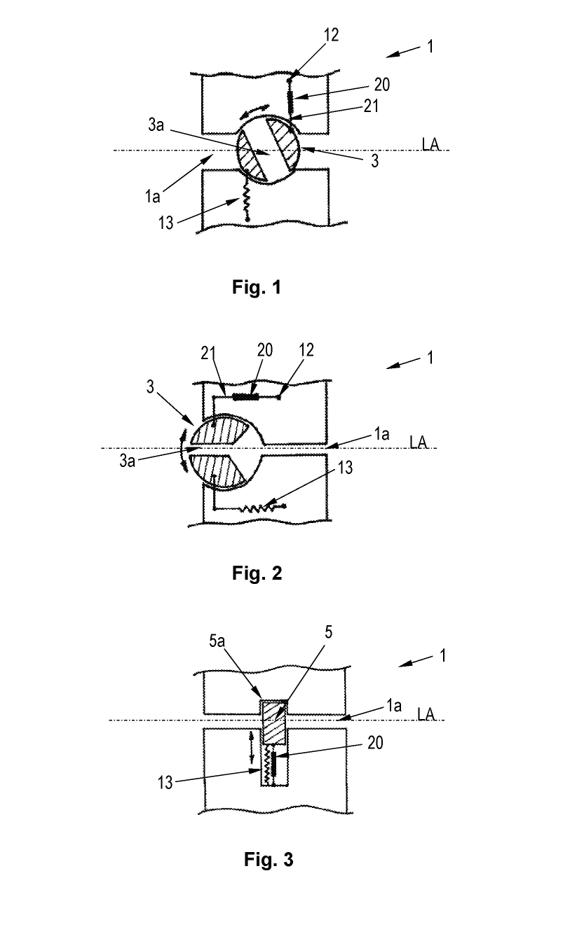

FIG. 1 shows an example of a means for controlling a nozzle 1 according to the invention, in particular, a rinsing head of an inspection and/or cleaning system. The nozzle comprises a nozzle housing, in which a fluid channel or water channel 1a is formed, through which a fluid, preferably water, flows, which is supplied to the rinsing head preferably under pressure, for example, via a rinsing hose. In the fluid channel or water channel 1a, a bolt 3 is arranged, which is formed substantially cylindrically. The bolt is arranged with respect to the water channel 1a such that the cylindrically shaped bolt substantially lies transversely with respect to the water channel 1a. The diameter of the bolt, hereby, is larger than the diameter of the water channel 1a, which preferably has a cylindrical cross section.

In the bolt 3, there is formed a channel 3a penetrating through the bolt, wherein the channel 3a runs through the bolt transversely. The channel 3a may have a circular cross section. However, the channel 3a may also have other cross sectional shapes. In the example shown here, the diameter of the channel 3a substantially is equal to the diameter of the water channel 1a. It may, however, also be wider or smaller than the diameter of the water channel 1a.

The bolt 3 is supported rotatably about its longitudinal axis within the water channel 1a or within the nozzle housing. Thereby, by rotating the bolt 3, water discharge from the nozzle may be blocked or released. By rotating the bolt such that the channel 3a of the bolt substantially is perpendicular to the longitudinal axis LA of the water channel 1a of the nozzle 1, the water channel 1a is blocked for water flowing through.

A setting means is assigned to the bolt 3, by means of which the bolt can be rotated in one direction. Further, a reset means 13 is assigned to the bolt 3, by means of which the bolt can be rotated in the opposite direction. The reset means 13, here, is configured as a spring member, and provides a reset force acting against the actuating force of the setting means.

According to the invention, the setting means comprises a shape memory member 20, which here is formed as an elongated shape memory member or as an elongated shape memory wire. Further, the setting means additionally comprises pulling members 21, which respectively are connected to the shape memory member 20 and to a fixation unit 12 or to the bolt 3. For example, wires, ropes, or the like may be used as pulling members 21. It is, however, advantageous, if the pulling members 21 upon application of a tractive force, do not change their length permanently.

In the embodiment of the setting means shown in FIG. 1 as well as the setting means shown in the following figures, the pulling members 21 may also be omitted, and the shape memory wire 20 may be fixed to the bolt or the respective setting means and at the fixation unit 12 directly.

For rotating the bolt 3, the setting means is shortened in that the shape memory member 20 is subjected to a physical unit, which causes the shape modification of the shape memory members 20. The shape modification of the shape memory member 20 preferably is such that the length of the shape memory member is reduced, and the setting means, thereby, applies a tractive force to the bolt effecting a rotation of the bolt. If the shape memory member 20 no longer is subjected to the physical unit, the shape memory member 20 returns to its original shape or length due to the reset force of the reset means 13, i.e., the setting means extends again such that the bolt 3 now is rotated in the opposite direction.

With respect to the embodiment of a means for controlling the nozzle according to the invention shown in FIG. 1 and with respect to the embodiments of a means for controlling a nozzle according to the invention described subsequently, such materials are used for the shape memory member, which upon a temperature change, for example, a temperature increase, change their shape or length. Preferably, the shape memory member is configured such that its length is reduced upon a temperature increase. However, also shape memory members may be used, according to which a temperature increase causes an increase of the length of the shape memory member.

The use of shape memory members as setting means or part of the setting means has the advantage that thereby, very strong setting forces can be achieved with very low material input and, in particular, with very low required space. Thereby, a very space-saving means for controlling a nozzle can be provided. Moreover, all nozzles of a rinsing head may be respectively be assigned to an own means for controlling, without having to substantially increase the size of the rinsing head itself for this. Thereby, particularly space-saving and compact rinsing heads are realizable, which nevertheless offer a preferably high degree of flexibility with respect to their applications.

Moreover, the shape memory members are not subject to wear, whereby the maintenance intervals for the maintenance of rinsing heads can be substantially prolonged.

It has been found to be particularly advantageous, if shape memory alloys or shape memory polymers may be used for the shape memory member 20, which have the so-called two-way effect. I.e., during cooling, they adopt their original shape or length again. Preferred shape memory alloys are, for example, nickel titanium, nickel titanium copper, copper zinc, copper zinc aluminum, copper aluminum nickel, iron nickel aluminum, iron manganese, or zinc gold copper.

The heating required for the shape modification or for shortening of the shape memory member 20 may, for example, result from resistor elements, from inductive heating, or the like. For example, the heating of the shape memory member 20 may be carried out directly from a current being supplied to the shape memory member 20 leads to the heating of the latter due to ohmic resistance.

According to a simple form, an electrical current is applied to the shape memory member, which causes a corresponding heating up of the shape memory member. For this, the shape memory member 20 may be coupled to a control and/or regulating means, which is arranged on a circuit board. The circuit board may be arranged at the fixation unit 12, and comprises terminals for control and/or data cables. Via the control/data cables, the control and/or regulation means may be connected to a control mechanism in order to control the respective means for controlling the nozzle.

The control and/or regulating means, alternatively, may also be coupled to the control mechanism via a wireless communications connection. The wireless communications connection has the advantage that no control and/or data cable has to be provided to the rinsing head, because such cables have to be introduced into the pipe to be cleaned parallel to the rinsing hose, and are subject to very strong wear, or may tear easily due to the mechanical stress. Therefore, it is advantageous to arrange a transmission/receiving module for the wireless communications connection at the rinsing head, which preferably is configured so as to establish a WLAN communications connection.

For the energy supply of the means for controlling the nozzles or for the transmission/receiving module, either the power supply integrated into the rinsing nozzle, for example, an accumulator, may be provided. Alternatively, the power may be provided by a water turbine arranged within the rinsing head, which is driven by the rinsing water supplied to the rinsing head.

The embodiment of the setting means described above, and, in particular, the description with respect to the shape memory member is also applicable accordingly to the setting means or the shape memory members, which are used in the examples according to FIG. 2 to FIG. 12.

FIG. 2 shows a further embodiment of a means for controlling a nozzle according to the invention. The control means, here, is formed by a bolt 3, which is rotated in one direction by means of a setting means, which comprises a shape memory member 20. By means of a reset means 13, the reset force of which acts opposite to the actuating force of the setting means, the bolt is rotated into the opposite direction.

A channel 3a is formed in the bolt 3, which here at the same time forms the water outlet channel of the nozzle. The bolt is formed cylindrically, whereby the channel 3a penetrates the bolt 3 in a transverse direction. The position of the bolt 3 with respect to the water channel 1a corresponds to the position of the bolt shown in FIG. 1. In the longitudinal direction of the water channel 1a, the bolt, however, is arranged within the nozzle housing such that the water outlet side of the channel 3a is arranged slightly outside of the nozzle housing such that upon rotation of the bolt 3, the outlet angle of the rinsing water being discharged from the channel 3a is modified.

On the water inlet side, the channel 3a has a larger diameter than on the water outlet side. In particular, the channel 3a, on the water inlet side, has a larger diameter than the end of the water channel 1a of the nozzle on the water inlet side. Thereby, it is ensured that upon rotation of the bolt 3, the latter does not cover the water channel 1a and thus inhibits water being discharged from the channel 3a.

FIG. 3 shows a further embodiment of the means for controlling a nozzle according to the invention. As control means, here, a latch 5 is provided, which is displaceable in transverse direction to the water channel 1a of the water nozzle 1 relative to the water channel 1a. Depending on the displacement position of the latch 5, the latter either clears the water channel 1a or blocks the water flow through the water channel 1a. In FIG. 3, the latch 5 is shown in a displacement position according to which the water flow through the water channel 1a is blocked, and thereby, no water may be discharged from the nozzle.

In a release position, i.e., in a displacement position according to which the latch 5 clears the water outlet, the latch is arranged in a recess, which also runs parallel to the transverse axis LA of the water channel 1a.

For moving the latch 5, the latter is coupled to an setting means comprising a shape memory member 20. For the reverse movement of the latch 5, the latter is coupled to a reset means, in particular, a return spring 13. The shape memory member 20, here, is configured such that an application of a temperature will lead to a shortening of the shape memory member 20 or the setting means, and the latch, therefore, will be brought into the release position. The return spring 13 then is configured as a pressure spring, which returns the latch 5 into the locking position, when the shape memory member 20 no longer is subjected to a temperature.

As an alternative to the configuration of the latch mechanism described above, the shape memory member 20 may also be configured such that an application of temperature to the shape memory member 20 leads to an elongation of the shape memory member 20, and thereby, the latch 5 is moved into the locking position. The return spring 13 then is configured such that it returns the latch 5 again into the release position, when the shape memory member 20 no longer is subjected to a temperature.

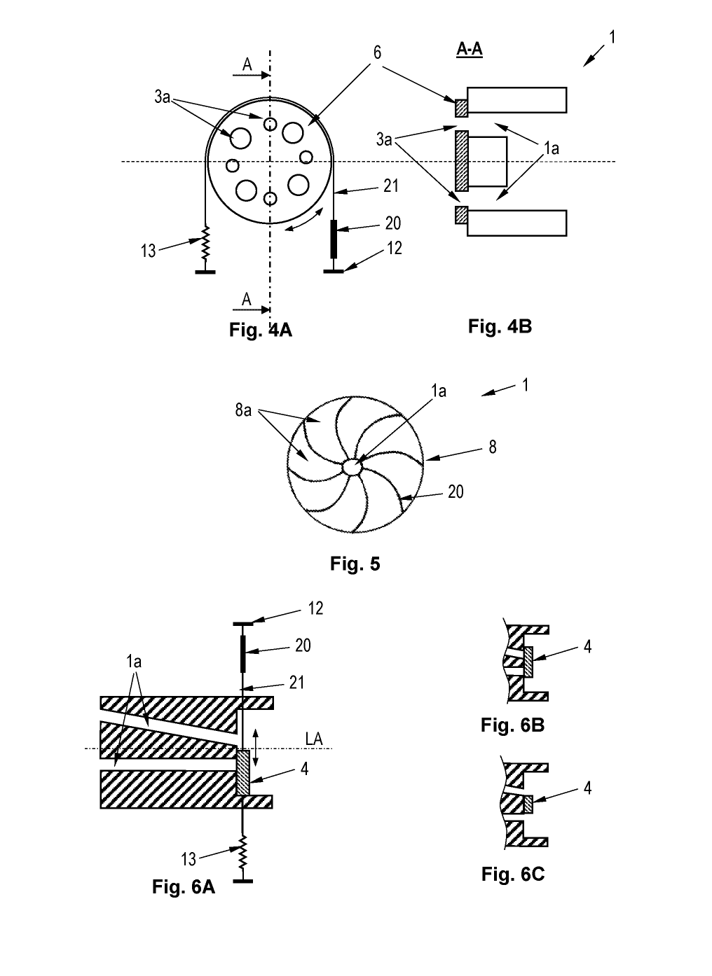

FIG. 4A shows a further embodiment of the means for controlling a nozzle according to the invention and FIG. 4B shows a cross section taken along line A-A of FIG. 4A. As control means, here, a circular aperture 6 is provided, which is arranged at the water outlet side rotatably at the nozzle 1. The circular aperture 6 has a plurality of holes 3a, which completely penetrate through the circular aperture, and the center of which corresponds to the longitudinal axis of the water channel 1a of the nozzle 1 in an appropriate rotational position. In this rotational position, the hole 3a clears the water outlet from the water channel 1a. Such a rotational position is shown in FIG. 4A.

The holes 3a of the circular aperture 6 may respectively have a different diameter such that by rotating the circular aperture 6, the cross section of the water outlet hole of the nozzle may be varied. In FIG. 4A, a rotational position of the circular aperture 6 is shown, according to which a water outlet through those holes 3a is realized, which have a smaller diameter.

The nozzle may have several water channels 1a, whereby the smaller holes and the larger holes preferably are arranged respectively in the circular aperture such that with a certain rotational position of the circular aperture on the one hand, all water channels 1a are opened, and on the other hand, all water outlet holes have the same diameter. Moreover, it is preferable, if the circular aperture 6 is rotatable into such a position, according to which all water outlet holes are closed. This may, for example, be achieved by rotating the disc such that the water channels 1a or the water outlet holes of the water channels 1a respectively are positioned between two holes 3a of the circular aperture 6.

The setting means, here, is formed by a shape memory member 20, which is fixed to a fixation unit 12. At the end facing away from the fixation unit 12, a pulling member 21 is attached, which is guided around the circular aperture 6 in radial direction. At the other end, the pulling member 21 is connected to the reset means 13, which here is configured as a spring member.

The portion of the pulling member 21 guided around the circular aperture 6, and the portion of the circular aperture 6 corresponding thereto, are at least partially formed as belt drive, preferably, as tooth belt drive. By pulling of the pulling member 21 at either one of its ends, the circular aperture 6 is rotated in the corresponding direction. By means of the configuration of the portion of the pulling member guided around the circular aperture 6 and the portion of the circular aperture corresponding thereto as belt drive, an optimal force transmission for rotation of the circular aperture is guaranteed, which is required for the prevailing water pressures.

Alternatively, the pulling member 21 arranged at the shape memory member 20 may also be guided partially around the circular aperture 6, and may be attached to the circular aperture 6. The return spring 13 may also be guided partially around the circular aperture 6 in radial direction, and may be attached to the circular aperture 6. The operating principle for rotation of the circular aperture 6, hereby, substantially corresponds to the operating principle mentioned above, whereby here, however, due to the attachment of the pulling member 21 and the spring member 13 to the circular aperture, a belt-drive-like configuration of the pulling member and the circular aperture may be omitted.

The configuration of the setting means and the reset means shown in FIG. 4 may also be used in a corresponding manner also for rotation of the bolts 3 shown in FIG. 1 and FIG. 2.

FIG. 5 shows a further embodiment of the means for controlling a nozzle.

The control means, here, are formed by a diaphragm or iris diaphragm 8, which comprises a number of blades 8a. By moving the blades by means of the setting means, the cross section of the water outlet hole may be extended or reduced. A shape memory member 20, for example, a shape memory wire, is respectively assigned to the blades 8a, the length of which is reduced upon an application of a temperature, and thus, causes a pivoting of the blades radially outwards such that the cross section of the water outlet hole is extended. A pivoting of the blades 8a radially inwards is achieved by a reset means (not shown in FIG. 5) respectively assigned to the blades.

The use of an iris diaphragm has the advantage that the cross section of the water outlet hole can be extended or reduced basically continuously.

FIGS. 6A-C show a further embodiment of the means for controlling a nozzle according to the invention.

The nozzle, here, has two fluid or water channels 1a, whereby one of the water channels is arranged so as to be inclined by a certain angle with respect to the other water channel. Thereby, the one water channel enables the outlet angle of the water being discharged to be different from the outlet angle of the water being discharged from the other water channel.

The control means, here, are formed as a slider 4, which is arranged at the water inlet side of the water channels 1a, and which is movable in radial direction relative to the nozzle. The movement of the slider 4 in one direction is caused by the setting means, while the movement into the other direction is caused by the reset means 13.

The slider 4, hereby, has a cross sectional area, which is at least as large as the larger diameter of the two water channels 1a. Thereby, it is ensured that the slider 4, with a suitable displacement position, may prevent water being discharged from the two water channels 1a.

In FIG. 6A, a slider 4 is shown, which blocks the lower water channel of the two water channels 1a in the displacement position shown there, and thereby prevents water being discharged from the lower water channel.

The slider 4 also may be dimensioned such that with a suitable displacement position, water being discharged from the two water channels is inhibited. In FIG. 6B, a slider 4 is shown, which covers both water channels 1a in the displacement position shown there, and thereby inhibits water being discharged from both water channels 1a.

According to an embodiment, the slider 4 may also be dimensioned such that in a suitable displacement position, it will allow water being discharged from both water channels 1a. A slider 4 being correspondingly configured is shown in FIG. 6C. With respect to the displacement position of the slider 4 shown in FIG. 6C, the water outlet from both water channels is cleared. By displacing the slider 4 upwards or downwards, the water outlet from the upper water channel or from the lower water channel is blocked.

Of course, also more water channels than the ones shown in FIGS. 6A-C may be provided.

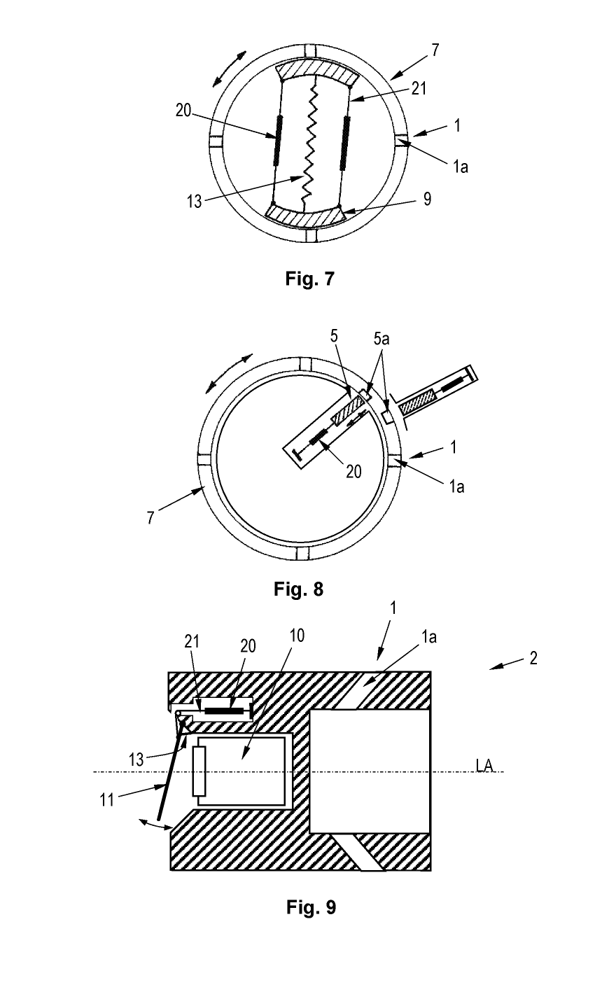

FIG. 7 shows an example of the means for controlling a nozzle according to the invention.

The nozzles, here, are arranged at a nozzle ring such that water substantially is being discharged from the water channels 1a in radial direction relative to the nozzle ring 7. The nozzle ring 7 may be arranged rotatably at a rinsing head such that the outlet angle of the water being discharged from the nozzles may be modified relative to the rinsing head. For setting of a predetermined outlet angle, the nozzle ring 7 is rotated as long as the corresponding outlet angle is obtained. In this position, the nozzle ring 7 is blocked by means of two brake shoes 9 such that the nozzle ring is not able to be rotated any further. The brake shoes are arranged with respect to the water channels 1a in a displaced manner with respect to the axial direction such that the brake shoes 9 do not interfere with the water being discharged from the nozzles 1a.

With respect to the embodiment shown in FIG. 7, the brake shoes 9 are arranged within the nozzle ring, and are pushed against the inner wall of the nozzle ring during braking. According to an alternative embodiment, the brake shoes 9 may also be arranged outside of the nozzle ring, and are pushed against an outer wall of the nozzle ring during braking.

In the embodiment shown in FIG. 7, the contact pressure is provided by the reset means 13, which here is configured as pressure spring. Release of the brake shoes, i.e., release of the nozzle ring 7, is accomplished by the setting means, which respectively comprise a shape memory member, in particular, a shape memory wire 20, the length of which is reduced upon application of temperature. Upon reducing the applied temperature, the length of the shape memory members 20 increases again, and the reset means 13 again pushes the brake shoes 9 against the inner wall of the nozzle ring.

According to an alternative embodiment, a shape memory member 20 may be also arranged between the two brake shoes 9, the length of which increases upon application of temperature such that the activated shape memory member pushes the two brake shoes 9 against the nozzle ring 7. In this case, the reset means 13 is configured as tension spring, which releases the brake shoes 9 again, if the shape memory members 20 no longer are subjected to a temperature.

FIG. 8 shows a further embodiment of a means for controlling a nozzle according to the invention. The nozzles 1, here, also are arranged at a nozzle ring 7, as described in further detail with respect to FIG. 7. Instead of the brake shoes, here, however, a latch 5 is provided as control means, which is movable in radial direction relative to the nozzle ring. In a locking position, the latch 5 engages with a recess 5a in the nozzle ring 7 such that rotation of the nozzle ring is inhibited. In a locking position, the nozzle ring 7 is released for rotation. The setting means may either be arranged radially inside of the nozzle ring or radially outside of the nozzle ring 7, whereby the recess 5a is provided at the inner wall of the nozzle ring or at the outer wall of the nozzle ring 7 correspondingly.

In the configuration of the setting means shown in FIG. 8, the latter comprises a shape memory member 20, which is connected to the latch 5 or to a fixation unit via pulling members. Upon activation of the shape memory member 20, i.e., upon application of temperature to the shape memory member, the latch 5 is moved from the locking position into the release position. A movement of the latch 5 from the release position into the locking position is accomplished by a reset means, which may be configured as a pressure spring (not shown in FIG. 8).

According to an alternative embodiment, a shape memory member 20 may be provided, which is coupled to the latch 5 and to the fixation unit 12 directly, and the length of which is increased upon application of temperature. The shape memory member then will move the latch 5 upon application of temperature from the release position into the locking position. Accordingly, a reset means 13 is provided, which brings the latch 5 from the locking position into the release position.

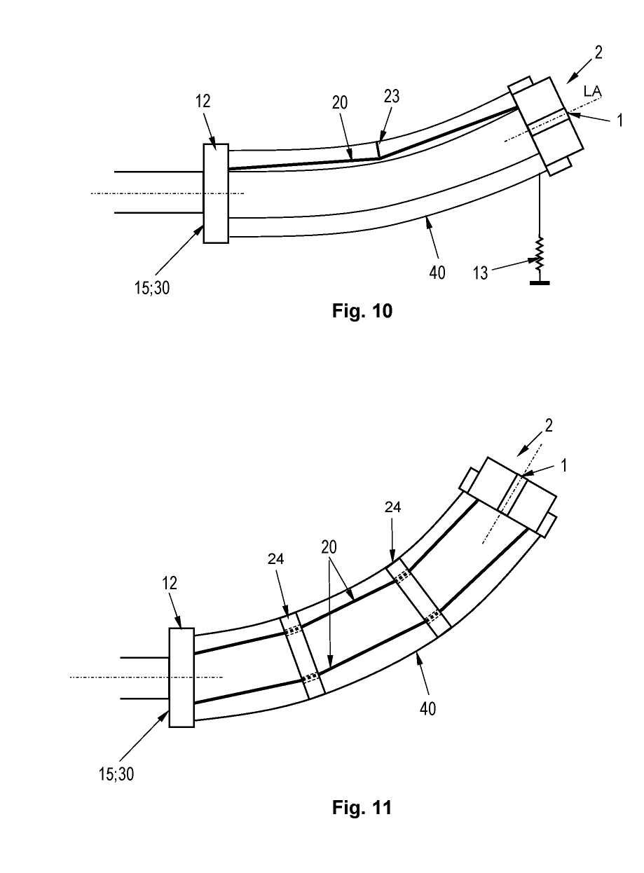

FIG. 9 shows a rinsing head according to the invention, in which several nozzles 1 are arranged. The nozzles 1 may be controlled respectively by a means according to the invention.

Further, a recess is provided at the front side of the rinsing head 2, in which an imaging means 10 may be arranged. Preferably, the imaging means 10 may be arranged within this recess releasably such that the imaging means may be replaced in a simple manner. The imaging means may comprise a video camera or a camera.

A cover 11 is arranged in front of the recess for the imaging means 10, which may be closed, for example, during a rinsing procedure in order to protect the imaging means 10 arranged within the recess. The cover 11 may be made from a transparent material.

The cover 11 is coupled to a setting means comprising a shape memory member 20. The shape memory member 20 is connected to the cover via a pulling member 21. In case the shape memory member 20 is subjected to a temperature, the length of the shape memory member 20 is reduced, and the cover 11 hinged pivotably at the rinsing head is opened. Moreover, the cover 11 is coupled to a reset means, as for example a return spring 13, which closes the cover 11 again, when the shape memory member 20 no longer is subjected to a temperature. The return spring 13 may also be arranged directly at the pivot axis.

In the embodiment shown here, the pulling member 21 is redirected by a deflection role and is guided to the cover.

For protection of the imaging means arranged within the recess, also an iris diaphragm shown with respect to FIG. 5 may be provided, whereby the iris diaphragm may be opened as far as it will not interfere with the field of vision of the imaging means 10.

FIG. 10 shows a further embodiment of a means for controlling a nozzle according to the invention. The nozzle 1 is arranged within the rinsing head 2. The rinsing head may comprise several nozzles, whereby the cross section of the water channels of the nozzles may be configured differently, and wherein the water channel of the nozzles may be orientated differently.

The rinsing head 2 is arranged at a front end of a flexible rinsing hose. In the rinsing hose 40, a water channel is formed through which the rinsing water is supplied to the rinsing head. At the other end of the rinsing hose 40, the latter is attached to a fixation unit 12 comprising a bore, through which the rinsing water may be supplied to the rinsing hose.

A shape memory member, in particular, a shape memory wire, is arranged within the wall of the rinsing hose, which, on the one hand, is fixed to the fixation unit 12, and on the other hand, to a further fixation unit at the front end of the rinsing hose, or at the rinsing head fixed to the other front end of the rinsing hose. By application of a temperature to the shape memory member 20, the length of the shape memory member is reduced. Due to the reduced length of the shape memory member, the rinsing hose is bent upwards. By means of a reset means 13, which here is configured as a return spring, the rinsing hose 40 is returned to a neutral position, when the shape memory member 20 no longer is subjected to a temperature.

Instead of a return spring 13, also a bending rod may be arranged within the rinsing hose, which has a certain reset force. After the deflection of the rinsing hose from its neutral position, the reset force of the bending rod causes the hose to be returned into its neutral position. According to an alternative embodiment, the rinsing hose 40 itself may have a certain reset force such that the rinsing hose may return to its neutral position autonomously, when the shape memory member 20 no longer is subjected to a temperature.

FIG. 11 shows a further embodiment of a means for controlling a nozzle according to the invention. The basic construction substantially corresponds to the embodiment shown in FIG. 10. In contrast to the embodiment shown in FIG. 10, the setting means here has two shape memory members or shape memory wires 20, which respectively are connected to the fixation unit 12 and to the rinsing nozzle 2, and are arranged in radial direction outside of the longitudinal axis of the rinsing hose, or are embedded within the wall of the rinsing hose. By providing two shape memory wires 20, the rinsing hose may be bent or deflected in two directions, namely, in the direction of the first shape memory wire and in the direction of the second shape memory wire. In case both shape memory members 20 are heated simultaneously such that the two shape memory members are reduced equally or differently, the rinsing hose 40 may also be deflected or bent into a direction lying in between the two shape memory members.

With respect to the embodiment shown in FIG. 6, the rinsing hose 40 has a number of guiding means 24 (here two), which may be configured as guiding discs, and which comprise a bore for each shape memory member running substantially parallel to the longitudinal axis of the rinsing hose. The shape memory wires 20 are passed through these bores. The guiding means or guiding rings 24 preferably are embedded within the wall of the rinsing hose 40.

The shape memory members or the shape memory wires 20 run through a channel within the wall of the rinsing head provided for this having a diameter, which is larger than the diameter of the shape memory wires. By means of the guiding means or guiding rings, it is ensured that the shape memory wires always run in a predetermined path for the shape memory wires within the channels during heating or during cooling as well as in a neutral position of the rinsing hose 40.

When providing three shape memory members or shape memory wires 20 being arranged in radial direction equally at the rinsing hose or within the wall of the rinsing hose, the rinsing hose 40 may be deflected within a range of 360° in any arbitrary direction and basically by any arbitrary amplitude, whereby the desired deflection direction and deflection amplitude are achieved by a corresponding heating of the respective shape memory wires 20. Also more than three shape memory wires may be provided in order to enable a deflection or bending of the rinsing hose in any arbitrary direction. If the three shape memory wires 20 are heated equally such that the shape memory wires respectively have the same length, the rinsing hose is in its neutral position. If the three shape memory wires are no longer subjected to a temperature, the reset means (cf. description for FIG. 10) causes the rinsing hose 40 to return to its neutral position again.

According to an embodiment of the invention, the wall of the rinsing hose itself may consist of a shape memory material. Thereby, preferably shape memory materials are used having the so-called two-way memory effect. Upon heating the rinsing hose wall, the shape of the rinsing hose changes such that the rinsing head arranged at the front end of the rinsing hose is deflected. During cooling of the rinsing hose wall, the rinsing hose returns to its original shape and returns to its neutral position. The return into the neutral position may be supported by a reset means 13.

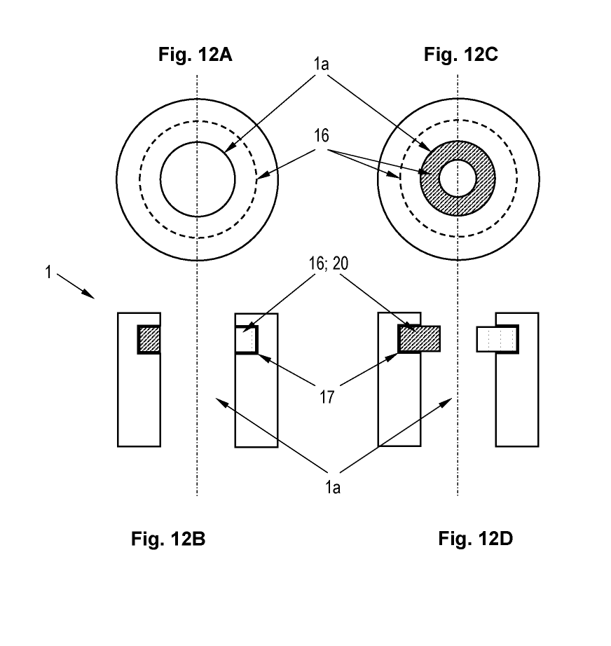

FIGS. 12A-D show still a further embodiment of a means for controlling a nozzle according to the invention.

In the water channel 1a, there is arranged a ring 16 concentrically with respect to the longitudinal axis of the water channel, which comprises a concentric through hole. The ring 16 engages with a circumferential groove 17 provided at the inner wall of the water channel.

The ring 16 is made from a shape memory material. Upon application of a temperature to the ring 16 consisting of a shape memory material, the latter adopts a shape according to which the through hole of the ring has a smaller diameter, as shown in FIGS. 12C and D. If the ring 16 no longer is subjected to a temperature, the latter adopts its original shape again, as shown in FIGS. 12A and B, and the diameter of the through hole of the ring is increased again.

Preferably, so called shape memory materials are used here, which comprise the so-called two-way memory effect. I.e., the ring 16 may “remember” two shapes, namely, the shape at a high temperature and a shape at a low temperature. Although the ring cannot perform work during cooling, no reset means have to be provided, because the ring during cooling neither has to perform work. The setting force of the ring 16 during increasing of the temperature is sufficient to reduce the diameter of the through hole of the ring even with water being discharged from the water channel under high pressure.

By means of the means for controlling a nozzle according to the invention, the nozzles may be produced in a compact manner. At the same time, the operating state, the diameter of the outlet opening and/or the outlet angle of the water being discharged from the nozzle may be adapted or adjusted to the respective requirements. Thereby, rinsing heads being particularly compact and usable in a particularly flexible manner may be realized. Moreover, electrical or electromechanical setting means may be omitted such that, on the one hand, a more economical production of rinsing heads is enabled, and on the other hand, the rinsing heads need less maintenance.

### REFERENCE NUMERALS

1 nozzle
1a water channel of nozzle 1
2 rinsing head with nozzles and, if needed, an imaging means 10
3 bolt with channel 3a
3a channel within bolt 3 or hole in the circular aperture 6
4 slider
5 latch
5a recess for receiving the latch 5
6 circular aperture (disc with channels 3a)
7 nozzle ring
8 diaphragm (iris diaphragm)
8a blades of the diaphragm 8
9 brake shoes
10 imaging means
11 cover
12 fixation unit
13 reset means, e.g., return spring
15 circuit board of the control and/or regulation means
16 ring
17 groove
20 shape memory member
21 pulling member (e.g., wire or rope)
23 deflection means (e.g., deflection roll)
24 guiding means
30 control and/or regulation means
40 rinsing hose
LA longitudinal axis

What is claimed is:

1. A controller for a nozzle, in particular, a nozzle of a rinsing head of an inspection and/or cleaning system, wherein
the nozzle comprises a nozzle housing, in which a fluid channel is formed, through which a pressurized fluid, in particular, water, supplied to the nozzle flows,
a control means is assigned to the nozzle, by means of which an operational state (open/closed), a cross section of a fluid outlet opening of the nozzle and/or an outlet angle of the fluid being discharged from the nozzle is adjustable,
the control means is coupled to a setting means in order to move the control means relative to the nozzle housing,
and wherein
the setting means comprises at least one shape memory member, which changes its shape depending on at least one parameter, wherein the change of shape of the shape memory member causes the movement of the control means relative to the nozzle housing.

2. The controller of claim 1, wherein the shape memory member comprises an elongated shape memory member, which changes its length depending on the parameter, and applies a setting force to the control means due to the change of length.

3. The controller of claim 1, wherein the setting means additionally comprises at least one pulling member, which, on the one hand, is connected to the shape memory member and, on the other hand, to the control means.

4. The controller of claim 1, wherein the parameter is the temperature of the shape memory member, and wherein the temperature required for a predetermined movement of the control means relative to the nozzle housing is applicable to the shape memory member directly or indirectly, wherein the shape memory member is coupled to a control and/or regulation means, which is adapted to apply a temperature required for a predetermined movement of the control means relative to the nozzle housing to the shape memory member.

5. The controller of claim 4, wherein the control and/or regulation means is adapted to supply electrical current to the shape memory member, or through the shape memory member in order to thereby heat it up.

6. The controller of claim 1, wherein the means comprises at least one reset means cooperating with the control means, wherein a reset force of the reset means acts against the setting force of the setting means.

7. The controller of claim 6, wherein the reset means comprises at least a spring member.

8. The controller of claim 1, wherein:
the control means comprises a cylindrically shaped bolt being arranged transversely with respect to the fluid channel and rotatably about its longitudinal axis, and having a diameter being larger than the diameter of the fluid channel, wherein the bolt comprises a channel running transversely through the bolt, and
the bolt is rotatable by means of the setting means from a first position, in which the channel of the bolt at least partially clears the fluid channel of the nozzle for letting the fluid flow through the fluid channel, into a second position, in which the bolt blocks the fluid channel of the nozzle for the fluid from flowing through the fluid channel.

9. The controller of claim 8, wherein:
the bolt is arranged relative to the fluid channel of the nozzle such that the channel of the bolt forms a water outlet channel of the nozzle, wherein a rotation of the bolt causes a modification of the outlet angle of the fluid being discharged from the nozzle, and/or
the channel of the bolt on its fluid inlet side has a larger diameter than on its fluid outlet side.

10. The controller of claim 1, wherein the control means comprises a latch being arranged transversely with respect to the fluid channel of the nozzle, and by means of which the setting means is movable in radial direction relative to the fluid channel, wherein the latch is movable from a first position, in which the latch locks the fluid channel of the nozzle for a fluid from flowing through the fluid channel, into a second position, in which the latch at least partially clears the fluid channel of the nozzle for a flow of the fluid through the fluid channel.

11. The controller of claim 1, wherein the control means comprises a circular aperture having a hole, which is arranged on the fluid channel outlet side rotatably at the nozzle, wherein in a first rotational position of the circular aperture relative to the nozzle, the hole corresponds to a fluid outlet opening of the fluid channel of the nozzle and clears the fluid outlet of the fluid channel through the hole, and wherein in a further rotational position of the circular aperture relative to the nozzle, the circular aperture inhibits a fluid being discharged from the fluid channel.

12. The controller of claim 1, wherein the control means comprises a diaphragm, in particular, an iris diaphragm, with several blades being movable with respect to each other and transversely with respect to the fluid channel, wherein the blades, on the fluid channel outlet side, are arranged at the nozzle, wherein at least one of the blades is coupled to the setting means and is movable with the setting means, wherein a movement of the blades causes an extension or a reduction of the cross section of the fluid outlet opening of the nozzle.

13. The controller of claim 1, wherein the control means comprises a slider, which is movable back and forth together with the setting means in radial direction transversely to the longitudinal axis of the nozzle between a first slider position and a second slider position, wherein in the nozzle housing, at least a first fluid channel and a second fluid channel are formed, wherein the slider in the first slider position inhibits fluid being discharged from the first fluid channel, and wherein in the second slider position, the slider inhibits fluid being discharged from the second fluid channel.

14. The controller of claim 1, wherein the nozzle housing comprises at least one nozzle ring, in which a fluid channel is formed, wherein the nozzle ring is supported rotatably in radial direction on the rinsing head, and wherein the control means comprises at least one brake shoe being movable together with the setting means and being pressed against an inner wall portion of the nozzle ring in order to block a rotation of the nozzle ring.

15. The controller of claim 1, wherein the nozzle housing comprises a nozzle ring, in which a fluid channel is formed, wherein the nozzle ring is rotatably supported in radial direction on the rinsing head, and wherein the control means comprises a latch being movable outwards and inwards together with the setting means relative to the nozzle in radial direction, wherein the nozzle ring comprises a recess engageable with the latch in order to block a rotation of the nozzle ring.

16. The controller of claim 1, wherein the control means comprises a rinsing hose, in which a water channel is formed, and at the front end of which at least one nozzle or a rinsing head is arranged, wherein the rinsing hose, in particular, the wall of the rinsing hose, comprises at least partially the shape memory member.

17. The controller of claim 1, wherein the control means comprises a ring being arranged coaxially with respect to the fluid channel within the fluid channel, and wherein the ring forms the shape memory member, wherein the ring changes its shape upon application of a parameter such that the diameter of the ring hole is reduced.

18. A rinsing head comprising at least one nozzle and at least one controller for the nozzle according to claim 1.

19. A pipe inspection or cleaning system comprising at least one nozzle and at least one controller for the nozzle according to claim 1 and at least one rinsing head comprising at least one nozzle and at least one controller.
